(19) United States
(12) Patent Application Publication
(10) Pub. No.: US 2020/0134767 A1
(43) Pub. Date: Apr. 30, 2020

(54) SYSTEMS AND METHODS FOR TRANSPORT CAPACITY SCHEDULING

(71) Applicant: BEIJING DIDI INFINITY TECHNOLOGY AND DEVELOPMENT CO., LTD., Beijing (CN)

(72) Inventors: Niping ZHANG, Beijing (CN); Lu LI, Beijing (CN)

(73) Assignee: BEIJING DIDI INFINITY TECHNOLOGY AND DEVELOPMENT CO., LTD., Beijing (CN)

(21) Appl. No.: 16/722,003

(22) Filed: Dec. 20, 2019

Related U.S. Application Data
(63) Continuation of application No. PCT/CN2018/087437, filed on May 18, 2018.

(30) Foreign Application Priority Data
Jul. 20, 2017 (CN) 201710595652.8

(51) Int. Cl. G06Q 50/30; G06Q 30/02; G06Q 10/06

(52) U.S. Cl. CPC G06Q 50/30; G06Q 10/06311; G06Q 30/0283

(57) ABSTRACT

A method for transport capacity scheduling in an online to offline service may include determining that a service requester intends to request an online to offline service. The method may also include determining a possibility to locate a target service provider in a first region for the service requester. The method may also include transmitting a scheduling message to a terminal of the service requester in response to a determination that the possibility to locate the target service provider in the first region is less than a possibility threshold. The method may also include receiving, from the terminal of the service requester, a requester response that the service requester allows locating the target service provider in the second region. The method may also include determining the target service provider in the second region based on the requester response.

### CROSS-REFERENCE TO RELATED APPLICATIONS

This application is a continuation of International Application No. PCT/CN2018/087437, filed on May 18, 2018, which claims priority to Chinese Patent Application No. 201710595652.8 filed on Jul. 20, 2017, the contents of which are incorporated herein by reference.

### TECHNICAL FIELD

The present disclosure relates to data processing for an online to offline service, and particularly, to systems and methods for transport capacity scheduling.

### BACKGROUND

Online to offline services (e.g., online taxi-hailing services) utilizing internet technology have become increasingly popular due to various benefits. For example, the online taxi-hailing services make it more convenient for users to travel to different destinations. When a service requester (e.g., a passenger) sends a service request to an online to offline service platform using a user terminal (e.g., a smartphone), the online to offline service platform may allocate the service request to a service provider (e.g., a driver). In some cases, the process of allocating a service request to a service provider includes presetting an allocation region and then allocating the service request to a service provider located within the preset allocation region. However, when the service requester sends the service request in peak hours, due to limited transportation capacity in the allocation region, it may be not possible to find an available service provider for the service requester. In the meantime, the available transport capacity outside the allocation region may not be fully utilized, resulting in a waste of resources. Therefore, there is a need for methods and systems that provide more efficient scheduling of transport capacity.

### SUMMARY

According to a first aspect of the present disclosure, a system for transport capacity scheduling in an online to offline service may include one or more storage media and one or more processors configured to communicate with the one or more storage media. The one or more storage media may include a set of instructions. When the one or more processors executing the set of instructions, the one or more processors may be directed to perform one or more of the following operations. The one or more processors may determine that a service requester intends to request an online to offline service. The online to offline service may include a departure location. The one or more processors may determine a possibility to locate a target service provider in a first region for the service requester. The one or more processors may transmit a scheduling message to a terminal of the service requester in response to a determination that the possibility to locate the target service provider in the first region is less than a possibility threshold. The scheduling message may be configured to inquire whether the service requester allows locating the target service provider in a second region that is different from the first region. The one or more processors may receive, from the terminal of the service requester, a requester response that the service requester allows locating the target service provider in the second region. The one or more processors may determine the target service provider in the second region based on the requester response.

In some embodiments, to determine the possibility to locate the target service provider in the first region for the online to offline service, the one or more processors may determine whether there is at least one available service provider in the first region. Alternatively or additionally, the one or more processors may determine a possibility that a time interval of waiting for a service request associated with the online to offline service being accepted by an available service provider in the first region is greater than an interval threshold.

In some embodiments, the requester response may include a longest travel time that is approved by the service requester for the target service provider to travel to the departure location, and/or a maximum scheduling price that is approved by the service requester to pay for assigning the target service provider to travel to the departure location before fulfilling the online to offline service. The second region may be determined based on at least one of the longest travel time or the maximum scheduling price.

In some embodiments, to determine the target service provider in the second region based on the requester response, the one or more processors may obtain a plurality of candidate service providers in the second region. The one or more processors may determine, for each of the plurality of candidate service providers, a travel time to the departure location, a travel distance to the departure location, or a scheduling price that the service requester pays for assigning the each of the plurality of candidate service providers to travel to the departure location. The one or more processors may select one or more candidate service providers of the plurality of candidate service providers based on the travel times, travel distances, or scheduling prices. The travel distances related to the selected one or more candidate service providers may be less than a distance threshold. The one or more processors may locate the target service provider from the selected one or more candidate service providers.

In some embodiments, to select the one or more candidate service providers of the plurality of candidate service providers, the one or more processors may select the selected one or more candidate service providers using a Kuhn-Munkras (KM) algorithm.

In some embodiments, to locate the target service provider from the selected one or more candidate service providers, the one or more processors may transmit the scheduling prices or the travel times associated with the selected one or more candidate service providers to the terminal of the service requester to prompt the service requester to select one of the selected one or more candidate service providers. The one or more processors may determine the target service provider based on a selection result received from the terminal of the service requester.

In some embodiments, to determine that the service requester intends to request the online to offline service, the one or more processors may detect that the service requester is inputting all or part of the departure location in an application on the terminal of the service requester before receiving a formal service request.

In some embodiments, to determine that the service requester intends to request the online to offline service, the one or more processors may receive a formal service request from the terminal of the service requester.

In some embodiments, the one or more processors may transmit information relating to the target service provider to the terminal of the service requester.

In some embodiments, in response to a determination that the possibility to locate the target service provider in the first region is greater than or equal to the possibility threshold, the one or more processors may locate the target service provider in the first region.

According to another aspect of the present disclosure, a method for transport capacity scheduling in an online to offline service may include one or more of the following operations. One or more processors may determine that a service requester intends to request an online to offline service. The online to offline service may include a departure location. The one or more processors may determine a possibility to locate a target service provider in a first region for the service requester. The one or more processors may transmit a scheduling message to a terminal of the service requester in response to a determination that the possibility to locate the target service provider in the first region is less than a possibility threshold. The scheduling message may be configured to inquire whether the service requester allows locating the target service provider in a second region that is different from the first region. The one or more processors may receive, from the terminal of the service requester, a requester response that the service requester allows locating the target service provider in the second region. The one or more processors may determine the target service provider in the second region based on the requester response.

According to yet another aspect of the present disclosure, a system for transport capacity scheduling in an online to offline service may comprise a response module configured to determine that a service requester intends to request an online to offline service. The online to offline service may include a departure location. The response module may be further configured to determine a possibility to locate a target service provider in a first region for the service requester. The system may also comprise a transmission module configured to transmit a scheduling message to a terminal of the service requester in response to a determination that the possibility to locate the target service provider in the first region is less than a possibility threshold. The scheduling message may be configured to inquire whether the service requester allows locating the target service provider in a second region that is different from the first region. The system may also comprise a detection module configured to receive, from the terminal of the service requester, a requester response that the service requester allows locating the target service provider in the second region. The system may also comprise an assigning module configured to determine the target service provider in the second region based on the requester response.

According to yet another aspect of the present disclosure, a non-transitory computer readable medium may comprise at least one set of instructions. The at least one set of instructions may be executed by one or more processors of a computer server. The one or more processors may determine that a service requester intends to request an online to offline service. The online to offline service may include a departure location. The one or more processors may determine a possibility to locate a target service provider in a first region for the service requester. The one or more processors may transmit a scheduling message to a terminal of the service requester in response to a determination that the possibility to locate the target service provider in the first region is less than a possibility threshold. The scheduling message may be configured to inquire whether the service requester allows locating the target service provider in a second region that is different from the first region. The one or more processors may receive, from the terminal of the service requester, a requester response that the service requester allows locating the target service provider in the second region. The one or more processors may determine the target service provider in the second region based on the requester response.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities, and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a schematic diagram illustrating an exemplary online to offline service system according to some embodiments of the present disclosure;

FIG. 2 is a schematic diagram illustrating exemplary hardware and/or software components of a computing device according to some embodiments of the present disclosure;

FIG. 3 is a schematic diagram illustrating exemplary hardware and/or software components of a mobile device according to some embodiments of the present disclosure;

FIG. 4 is a block diagram illustrating an exemplary processing engine according to some embodiments of the present disclosure;

FIG. 5 is a block diagram illustrating an exemplary mobile device according to some embodiments of the present disclosure;

FIG. 6 is a flowchart illustrating an exemplary process for transport capacity scheduling according to some embodiments of the present disclosure;

FIG. 7 is a flowchart illustrating an exemplary process for transport capacity scheduling according to some embodiments of the present disclosure;

FIGS. 8 to 10 are schematic diagrams of an interface of a requester terminal associated with a service requester according to an embodiment of the present disclosure; and

FIGS. 11 to 13 are schematic diagrams of an interface of a requester terminal associated with a service requester according to an embodiment of the present disclosure.

### DETAILED DESCRIPTION

The following description is presented to enable any person skilled in the art to make and use the present disclosure and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown but is to be accorded the widest scope consistent with the claims.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprise,” “comprises,” and/or “comprising,” “include,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

These and other features, and characteristics of the present disclosure, as well as the methods of operation and functions of the related elements of structure and the combination of parts and economies of manufacture, may become more apparent upon consideration of the following description with reference to the accompanying drawings, all of which form a part of this disclosure. It is to be expressly understood, however, that the drawings are for the purpose of illustration and description only and are not intended to limit the scope of the present disclosure. It is understood that the drawings are not to scale.

The flowcharts used in the present disclosure illustrate operations that systems implement according to some embodiments of the present disclosure. It is to be expressly understood, the operations of the flowchart may be implemented not in order. Conversely, the operations may be implemented in inverted order, or simultaneously. Moreover, one or more other operations may be added to the flowcharts. One or more operations may be removed from the flowcharts.

Moreover, while the systems and methods disclosed in the present disclosure are described primarily regarding transport capacity scheduling in a taxi-hailing service, it should also be understood that this is only one exemplary embodiment. The system or method of the present disclosure may be applied to any other kind of online to offline service. For example, the system or method of the present disclosure may be applied to transportation systems of different environments including land, ocean, aerospace, or the like, or any combination thereof. The vehicle of the transportation systems may include a taxi, a private car, a hitch, a bus, a train, a bullet train, a high-speed rail, a subway, a vessel, an aircraft, a spaceship, a hot-air balloon, a driverless vehicle, or the like, or any combination thereof. The transportation system may also include any transportation system for management and/or distribution, for example, a system for sending and/or receiving an express, a system for a take-out service. The application of the system or method of the present disclosure may include a webpage, a plug-in of a browser, a client terminal, a custom system, an internal analysis system, an artificial intelligence robot, or the like, or any combination thereof.

The terms “passenger,” “requester,” “requestor,” “service requester,” “service requestor,” and “customer” in the present disclosure are used interchangeably to refer to an individual, an entity or a tool that may request or order a service. Also, the terms “driver,” “provider,” “service provider,” and “supplier” in the present disclosure are used interchangeably to refer to an individual, an entity or a tool that may provide a service or facilitate the providing of the service. The term “user” in the present disclosure may refer to an individual, an entity or a tool that may request a service, order a service, provide a service, or facilitate the providing of the service. In the present disclosure, terms “requester” and “requester terminal” may be used interchangeably, and terms “provider” and “provider terminal” may be used interchangeably.

The terms “request,” “service,” “service request,” and “order” in the present disclosure are used interchangeably to refer to a request that may be initiated by a passenger, a requester, a service requester, a customer, a driver, a provider, a service provider, a supplier, or the like, or any combination thereof. The service request may be accepted by any one of a passenger, a requester, a service requester, a customer, a driver, a provider, a service provider, or a supplier. The service request may be chargeable or free.

The positioning technology used in the present disclosure may be based on a global positioning system (GPS), a global navigation satellite system (GLONASS), a compass navigation system (COMPASS), a Galileo positioning system, a quasi-zenith satellite system (QZSS), a wireless fidelity (WiFi) positioning technology, or the like, or any combination thereof. One or more of the above positioning systems may be used interchangeably in the present disclosure.

An aspect of the present disclosure relates to systems and methods for transportation capacity scheduling in an online to offline service. After a passenger sends out a service request to an online to offline service platform through his/her smartphone, the online to offline service platform may find, for the passenger, an available driver in a region relatively closer to the passenger to accept the service request. When the transportation capacity in the first region are not enough to find an available driver for the passenger, the online to offline service platform may transmit a scheduling message to the smartphone of the passenger to inquire whether the passenger allows locating an available driver in a region relatively farther away from the passenger. If the online to offline service platform receives a response indicating that the passenger allows locating an available driver in a relatively farther region from the smartphone of the passenger, the online to offline service platform may find an available driver in the relatively farther region for the passenger.

It should be noted that an online to offline service, such as online taxi-hailing including taxi hailing combination services, is a new form of service rooted only in post-Internet era. It provides technical solutions to users and service providers that could raise only in post-Internet era. In pre-Internet era, when a passenger hails a taxi on the street, the taxi request and acceptance occur only between the passenger and one taxi driver that sees the passenger. If the passenger hails a taxi through a telephone call, the service request and acceptance may occur only between the passenger and one service provider (e.g., one taxi company or agent). Online taxi, however, allows a user of the service to real-time and automatically distribute a service request to a vast number of individual service providers (e.g., taxi) distance away from the user. It also allows a plurality of service providers to respond to the service request simultaneously and in real-time. Therefore, through the Internet, the online to offline service system may provide a much more efficient transaction platform for the users and the service providers that may never meet in a traditional pre-Internet transportation service system.

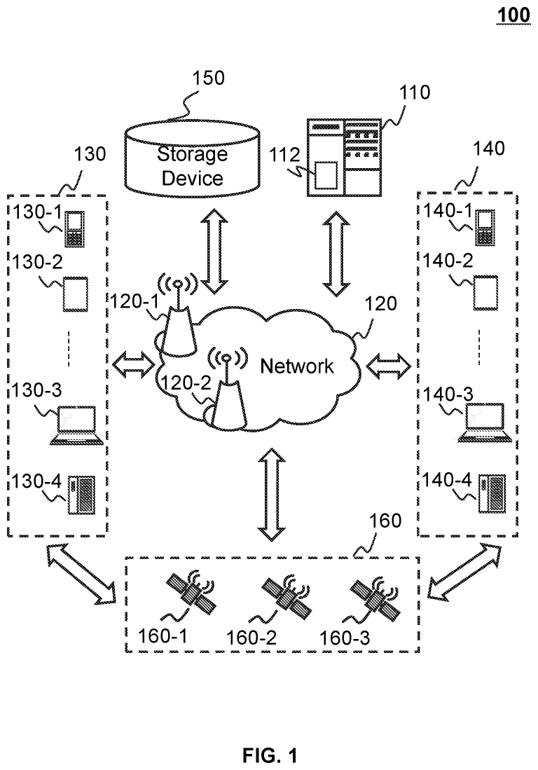

FIG. 1 is a schematic diagram illustrating an exemplary online to offline service system according to some embodiments of the present disclosure. For example, the online to offline service system 100 may be an online transportation service platform for transportation services such as taxi hailing, chauffeur services, delivery vehicles, express car, carpool, bus service, driver hiring, take-out services, and shuttle services. The online to offline service system 100 may include a server 110, a network 120, a requester terminal 130, a provider terminal 140, a storage device 150, and a positioning system 160.

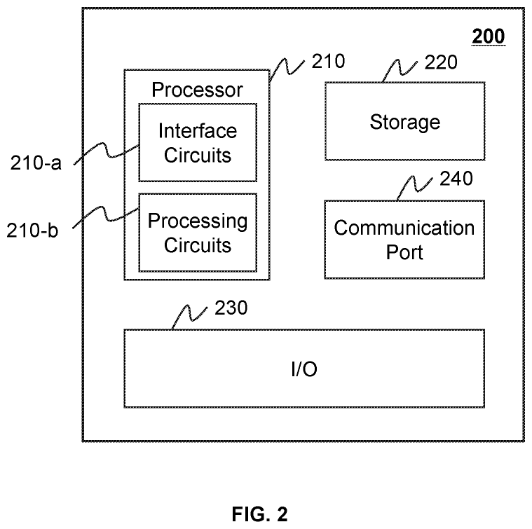

In some embodiments, the server 110 may be a single server, or a server group. The server group may be centralized, or distributed (e.g., the server 110 may be a distributed system). In some embodiments, the server 110 may be local or remote. For example, the server 110 may access information and/or data stored in the requester terminal 130, the provider terminal 140, the storage device 150 and/or the positioning system 160 via the network 120. As another example, the server 110 may be directly connected to the requester terminal 130, the provider terminal 140, the storage device 150 and/or the positioning system 160 to access stored information and/or data. In some embodiments, the server 110 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof. In some embodiments, the server 110 may be implemented on a computing device 200 having one or more components illustrated in FIG. 2.

In some embodiments, the server 110 may include a processing engine 112. The processing engine 112 may process information and/or data relating to a service request to perform one or more functions described in the present disclosure. For example, the processing engine 112 may determine a service provider for a service requester. In some embodiments, the processing engine 112 may include one or more processing engines (e.g., single-core processing engine(s) or multi-core processor(s)). The processing engine 112 may include a central processing unit (CPU), an application-specific integrated circuit (ASIC), an application-specific instruction-set processor (ASIP), a graphics processing unit (GPU), a physics processing unit (PPU), a digital signal processor (DSP), a field programmable gate array (FPGA), a programmable logic device (PLD), a controller, a microcontroller unit, a reduced instruction-set computer (RISC), a microprocessor, or the like, or any combination thereof.

The network 120 may facilitate exchange of information and/or data. In some embodiments, one or more components of the online to offline service system 100 (e.g., the server 110, the requester terminal 130, the provider terminal 140, the storage device 150 and/or the positioning system 160) may transmit information and/or data to other component(s) of the online to offline service system 100 via the network 120. For example, the server 110 may obtain a service request from the requester terminal 130 via the network 120. In some embodiments, the network 120 may be any type of wired or wireless network, or any combination thereof. Merely by way of example, the network 120 may include a cable network, a wireline network, an optical fiber network, a telecommunications network, an intranet, an Internet, a local area network (LAN), a wide area network (WAN), a wireless local area network (WLAN), a metropolitan area network (MAN), a public telephone switched network (PSTN), a Bluetooth network, a ZigBee network, a near field communication (NFC) network, or the like, or any combination thereof. In some embodiments, the network 120 may include one or more network access points. For example, the network 120 may include wired or wireless network access points such as base stations and/or internet exchange points 120-1, 120-2, . . . , through which one or more components of the online to offline service system 100 may be connected to the network 120 to exchange data and/or information.

In some embodiments, a service requester may be a user of the requester terminal 130. In some embodiments, the user of the requester terminal 130 may be someone other than the service requester. For example, a user A of the requester terminal 130 may use the requester terminal 130 to send a service request for a user B or receive a service confirmation and/or information or instructions from the server 110. In some embodiments, a service provider may be a user of the provider terminal 140. In some embodiments, the user of the provider terminal 140 may be someone other than the service provider. For example, a user C of the provider terminal 140 may use the provider terminal 140 to receive a service request for a user D, and/or information or instructions from the server 110.

In some embodiments, the requester terminal 130 may include a mobile device 130-1, a tablet computer 130-2, a laptop computer 130-3, a built-in device in a vehicle 130-4, or the like, or any combination thereof. In some embodiments, the mobile device 130-1 may include a smart home device, a wearable device, a smart mobile device, a virtual reality device, an augmented reality device, or the like, or any combination thereof. In some embodiments, the smart home device may include a smart lighting device, a control device of an intelligent electrical apparatus, a smart monitoring device, a smart television, a smart video camera, an interphone, or the like, or any combination thereof. In some embodiments, the wearable device may include a smart bracelet, a smart footgear, a smart glass, a smart helmet, a smart watch, a smart clothing, a smart backpack, a smart accessory, or the like, or any combination thereof. In some embodiments, the smart mobile device may include a smartphone, a personal digital assistance (PDA), a gaming device, a navigation device, a point of sale (POS) device, or the like, or any combination thereof. In some embodiments, the virtual reality device and/or the augmented reality device may include a virtual reality helmet, a virtual reality glass, a virtual reality patch, an augmented reality helmet, an augmented reality glass, an augmented reality patch, or the like, or any combination thereof. For example, the virtual reality device and/or the augmented reality device may include a Google Glass™, an Oculus Rift™, a Hololens™, a Gear VR™, etc. In some embodiments, a built-in device in the vehicle 130-4 may include an onboard computer, an onboard television, etc. In some embodiments, the requester terminal 130 may be a device with positioning technology for locating the location of the service requester and/or the requester terminal 130.

In some embodiments, the provider terminal 140 may be similar to, or the same device as the requester terminal 130. In some embodiments, the provider terminal 140 may be a device with positioning technology for locating the location of the service provider and/or the provider terminal 140. In some embodiments, the requester terminal 130 and/or the provider terminal 140 may communicate with other positioning device to determine the location of the service requester, the requester terminal 130, the service provider, and/or the provider terminal 140. In some embodiments, the requester terminal 130 and/or the provider terminal 140 may send positioning information to the server 110.

The storage device 150 may store data and/or instructions relating to a service request. In some embodiments, the storage device 150 may store data obtained from the requester terminal 130 and/or the provider terminal 140. For example, the storage device 150 may store a service request and/or a requester response obtained from the requester terminal 130. In some embodiments, the storage device 150 may store data and/or instructions that the server 110 may execute or use to perform exemplary methods described in the present disclosure. For example, the storage device 150 may store data and/or instructions for finding a service provider for a service requester. In some embodiments, the storage device 150 may store location information related to the requester terminal 130 and/or the provider terminal 140. In some embodiments, the storage device 150 may include a mass storage, a removable storage, a volatile read-and-write memory, a read-only memory (ROM), or the like, or any combination thereof. Exemplary mass storage may include a magnetic disk, an optical disk, a solid-state drive, etc. Exemplary removable storage may include a flash drive, a floppy disk, an optical disk, a memory card, a zip disk, a magnetic tape, etc. Exemplary volatile read-and-write memory may include a random access memory (RAM). Exemplary RAM may include a dynamic RAM (DRAM), a double date rate synchronous dynamic RAM (DDR SDRAM), a static RAM (SRAM), a thyristor RAM (T-RAM), and a zero-capacitor RAM (Z-RAM), etc. Exemplary ROM may include a mask ROM (MROM), a programmable ROM (PROM), an erasable programmable ROM (EPROM), an electrically erasable programmable ROM (EEPROM), a compact disk ROM (CD-ROM), and a digital versatile disk ROM, etc. In some embodiments, the storage device 150 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

In some embodiments, the storage device 150 may be connected to the network 120 to communicate with one or more components of the online to offline service system 100 (e.g., the server 110, the requester terminal 130, the provider terminal 140, and/or the positioning system 160). One or more components of the online to offline service system 100 may access the data and/or instructions stored in the storage device 150 via the network 120. In some embodiments, the storage device 150 may be directly connected to or communicate with one or more components of the online to offline service system 100 (e.g., the server 110, the requester terminal 130, the provider terminal 140, and/or the positioning system 160). In some embodiments, the storage device 150 may be part of the server 110.

In some embodiments, one or more components of the online to offline service system 100 (e.g., the server 110, the requester terminal 130, the provider terminal 140) may have permissions to access the storage device 150. In some embodiments, one or more components of the online to offline service system 100 may read and/or modify information relating to the service requester, the service provider, and/or the public when one or more conditions are met. For example, the server 110 may read and/or modify one or more service requesters' information after a service is completed. As another example, the provider terminal 140 may access information relating to the service requester when receiving a service request from the requester terminal 130, but the provider terminal 140 may not modify the relevant information of the service requester.

The positioning system 160 may determine location information associated with an object, for example, the requester terminal 130 and/or the provider terminal 140. In some embodiments, the positioning system 160 may be a global positioning system (GPS), a global navigation satellite system (GLONASS), a compass navigation system (COMPASS), a BeiDou navigation satellite system, a Galileo positioning system, a quasi-zenith satellite system (QZSS), etc. The information may include a location, an elevation, a velocity, or an acceleration of the object, an accumulative mileage number, or a current time. The location may be in the form of coordinates, such as, latitude coordinate and longitude coordinate, etc. The positioning system 160 may include one or more satellites, for example, a satellite 160-1, a satellite 160-2, and a satellite 160-3. The satellites 160-1 through 160-3 may determine the information mentioned above independently or jointly. The satellite positioning system 160 may send the information mentioned above to the network 120, the requester terminal 130, or the provider terminal 140 via wireless connections.

In some embodiments, information exchanging of one or more components of the online to offline service system 100 may be achieved by way of requesting a service. The object of the service may be any product. In some embodiments, the product may be a tangible product or an immaterial product. The tangible product may include food, medicine, commodity, chemical product, electrical appliance, clothing, car, housing, luxury, or the like, or any combination thereof. The immaterial product may include a servicing product, a financial product, a knowledge product, an internet product, or the like, or any combination thereof. The internet product may include an individual host product, a web product, a mobile internet product, a commercial host product, an embedded product, or the like, or any combination thereof. The mobile internet product may be used in a software of a mobile terminal, a program, a system, or the like, or any combination thereof. The mobile terminal may include a tablet computer, a laptop computer, a mobile phone, a personal digital assistance (PDA), a smart watch, a point of sale (POS) device, an onboard computer, an onboard television, a wearable device, or the like, or any combination thereof. For example, the product may be any software and/or application used in the computer or mobile phone. The software and/or application may relate to socializing, shopping, transporting, entertainment, learning, investment, or the like, or any combination thereof. In some embodiments, the software and/or application relating to transporting may include a traveling software and/or application, a vehicle scheduling software and/or application, a mapping software and/or application, etc. In the vehicle scheduling software and/or application, the vehicle may include a horse, a carriage, a rickshaw (e.g., a wheelbarrow, a bike, a tricycle), a car (e.g., a taxi, a bus, a private car), a train, a subway, a vessel, an aircraft (e.g., an airplane, a helicopter, a space shuttle, a rocket, a hot-air balloon), or the like, or any combination thereof.

One of ordinary skill in the art would understand that when an element of the online to offline service system 100 performs, the element may perform through electrical signals and/or electromagnetic signals. For example, when the server 110 processes a task, such as obtain a service request via the network 120, the server 110 may operate logic circuits in its processor to process such task. When the server 110 transmit a scheduling message, a processor of the server 110 may generate electrical signals encoding the scheduling message. The processor of the server 110 may then send the electrical signals to at least one information exchange port associated with the server 110. The server 110 communicates with the online to offline service system 100 via a wired network, the at least one information exchange port may be physically connected to a cable, which may further transmit the electrical signals to an input port (e.g., an information exchange port) of the requester terminal 130. If the server 110 communicates with the online to offline service system 100 via a wireless network, the at least one information exchange port may be one or more antennas, which may convert the electrical signals to electromagnetic signals. Within an electronic device, such as the requester terminal 130, and/or the server 110, when a processor thereof processes an instruction, sends out an instruction, and/or performs an action, the instruction and/or action is conducted via electrical signals. For example, when the processor retrieves or saves data from a storage medium (e.g., the storage device 150), it may send out electrical signals to a read/write device of the storage medium, which may read or write structured data in the storage medium. The structured data may be transmitted to the processor in the form of electrical signals via a bus of the electronic device. Here, an electrical signal may be one electrical signal, a series of electrical signals, and/or a plurality of discrete electrical signals.

FIG. 2 is a schematic diagram illustrating exemplary hardware and/or software components of a computing device according to some embodiments of the present disclosure. In some embodiments, the server 110, the requester terminal 130, and/or the provider terminal 140 may be implemented on the computing device 200. For example, the processing engine 112 may be implemented on the computing device 200 and configured to perform functions of the processing engine 112 disclosed in this disclosure.

The computing device 200 may be configured to implement any component of the online to offline service system 100 as described herein. For example, the processing engine 112 may be implemented on the computing device 200, via its hardware, software program, firmware, or a combination thereof. Although only one such computer is shown, for convenience, the computer functions relating to the online to offline service as described herein may be implemented in a distributed fashion on a number of similar platforms to distribute the processing load.

As illustrated in FIG. 2, the computing device 200 may include a processor 210, a storage 220, an input/output (I/O) 230, and a communication port 240. The processor 210 (e.g., logic circuits) may execute computer instructions (e.g., program code) and perform functions of the processing engine 112 in accordance with techniques described herein. For example, the processor 210 may include interface circuits 210-a and processing circuits 210-b therein. The interface circuits may be configured to receive electronic signals from a bus (not shown in FIG. 2), wherein the electronic signals encode structured data and/or instructions for the processing circuits to process. The processing circuits may conduct logic calculations, and then determine a conclusion, a result, and/or an instruction encoded as electronic signals. Then the interface circuits may send out the electronic signals from the processing circuits via the bus.

The computer instructions may include, for example, routines, programs, objects, components, data structures, procedures, modules, and functions, which perform particular functions described herein. For example, the processor 210 may find a service provider for a service requester. In some embodiments, the processor 210 may include one or more hardware processors, such as a microcontroller, a microprocessor, a reduced instruction set computer (RISC), an application specific integrated circuits (ASICs), an application-specific instruction-set processor (ASIP), a central processing unit (CPU), a graphics processing unit (GPU), a physics processing unit (PPU), a microcontroller unit, a digital signal processor (DSP), a field programmable gate array (FPGA), an advanced RISC machine (ARM), a programmable logic device (PLD), any circuit or processor capable of executing one or more functions, or the like, or any combinations thereof.

Merely for illustration, only one processor is described in the computing device 200. However, it should be noted that the computing device 200 in the present disclosure may also include multiple processors, thus operations and/or method steps that are performed by one processor as described in the present disclosure may also be jointly or separately performed by the multiple processors. For example, if in the present disclosure the processor of the computing device 200 executes both step A and step B, it should be understood that step A and step B may also be performed by two or more different processors jointly or separately in the computing device 200 (e.g., a first processor executes step A and a second processor executes step B, or the first and second processors jointly execute steps A and B).

The storage 220 may store data/information obtained from the requester terminal 130, the provider terminal 140, the storage device 150, and/or any other component of the online to offline service system 100. In some embodiments, the storage 220 may include a mass storage, a removable storage, a volatile read-and-write memory, a read-only memory (ROM), or the like, or any combination thereof. For example, the mass storage may include a magnetic disk, an optical disk, a solid-state drives, etc. The removable storage may include a flash drive, a floppy disk, an optical disk, a memory card, a zip disk, a magnetic tape, etc. The volatile read-and-write memory may include a random access memory (RAM). The RAM may include a dynamic RAM (DRAM), a double date rate synchronous dynamic RAM (DDR SDRAM), a static RAM (SRAM), a thyristor RAM (T-RAM), and a zero-capacitor RAM (Z-RAM), etc. The ROM may include a mask ROM (MROM), a programmable ROM (PROM), an erasable programmable ROM (EPROM), an electrically erasable programmable ROM (EEPROM), a compact disk ROM (CD-ROM), and a digital versatile disk ROM, etc. In some embodiments, the storage 220 may store one or more programs and/or instructions to perform exemplary methods described in the present disclosure. For example, the storage 220 may store a program for the processing engine 112 for finding a service provider for a service requester.

The I/O 230 may input and/or output signals, data, information, etc. In some embodiments, the I/O 230 may enable a user interaction with the processing engine 112. In some embodiments, the I/O 230 may include an input device and an output device. Examples of the input device may include a keyboard, a mouse, a touch screen, a microphone, or the like, or a combination thereof. Examples of the output device may include a display device, a loudspeaker, a printer, a projector, or the like, or a combination thereof. Examples of the display device may include a liquid crystal display (LCD), a light-emitting diode (LED)-based display, a flat panel display, a curved screen, a television device, a cathode ray tube (CRT), a touch screen, or the like, or a combination thereof.

The communication port 240 may be connected to a network (e.g., the network 120) to facilitate data communications. The communication port 240 may establish connections between the processing engine 112 and the requester terminal 130, the provider terminal 140, the positioning system 160, or the storage device 150. The connection may be a wired connection, a wireless connection, any other communication connection that can enable data transmission and/or reception, and/or any combination of these connections. The wired connection may include, for example, an electrical cable, an optical cable, a telephone wire, or the like, or any combination thereof. The wireless connection may include, for example, a Bluetooth™ link, a Wi-Fi™ link, a WiMax™ link, a WLAN link, a ZigBee link, a mobile network link (e.g., 3G, 4G, 5G, etc.), or the like, or a combination thereof. In some embodiments, the communication port 240 may be and/or include a standardized communication port, such as RS232, RS485, etc.

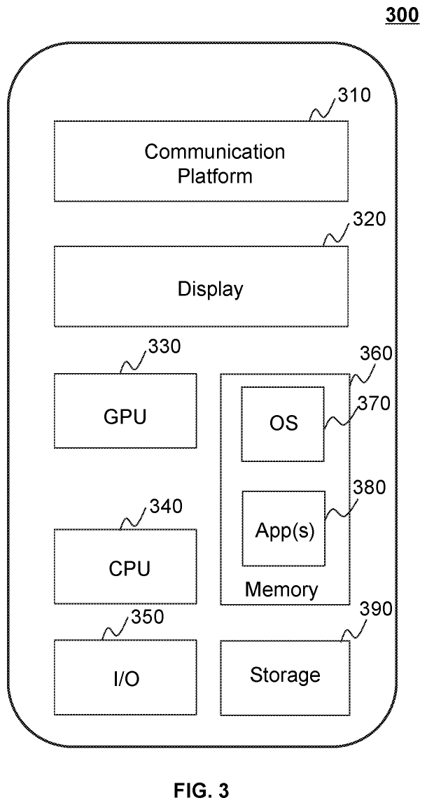

FIG. 3 is a schematic diagram illustrating exemplary hardware and/or software components of a mobile device on which the requester terminal 130 and/or the provider terminal 140 may be implemented according to some embodiments of the present disclosure. As illustrated in FIG. 3, the mobile device 300 may include a communication platform 310, a display 320, a graphic processing unit (GPU) 330, a central processing unit (CPU) 340, an I/O 350, a memory 360, a mobile operating system (OS) 370, and a storage 390. In some embodiments, any other suitable component, including but not limited to a system bus or a controller (not shown), may also be included in the mobile device 300.

In some embodiments, the mobile operating system 370 (e.g., iOS™, Android™, Windows Phone™, etc.) and one or more applications 380 may be loaded into the memory 360 from the storage 390 in order to be executed by the CPU 340. The applications 380 may include a browser or any other suitable mobile apps for receiving and rendering information relating to online to offline services or other information from the online to offline service system 100. User interactions with the information stream may be achieved via the I/O 350 and provided to the processing engine 112 and/or other components of the online to offline service system 100 via the network 120.

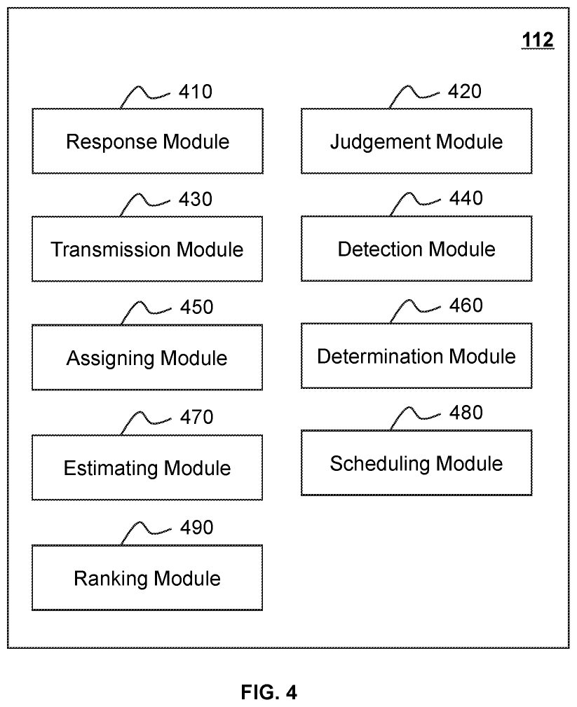

FIG. 4 is a block diagram illustrating an exemplary processing engine according to an embodiment of the present disclosure. In some embodiments, the processing engine 112 shown in FIG. 4 may be implemented on the server 110 of the online to offline service system 100 shown in FIG. 1. As illustrated in FIG. 4, the processing engine 112 may include a response module 410, a judgement module 420, a transmission module 430, a detection module 440, an assigning module 450, a determination module 460, an estimation module 470, a scheduling module 480 and a ranking module 490.

The response module 410 may receive information from a requester terminal 130 associated with a service requester. In some embodiments, the response module 410 may receive a service intention, a service request, and/or a requester response from a service requester via the requester terminal 130. The service intention may indicate an interest to make a service request before an actual service request is made. For example, if the service requester inputs all or part of a destination on the user interface of the requester terminal 130 but the actual service request is not made yet, the response module 410 may receive the service intention including the destination. The service request may include information such as a start location, a destination, a user ID of the service requester, or the like, or any combination thereof. The requester response may indicate whether the service requester agrees with the transport capacity scheduling.

The judgement module 420 may determine whether to send a scheduling message and/or whether to locate a target service provider in a second region. In some embodiments, the online to offline service system 100 may be preset to locate the target service provider in a first region. The second region may be different from the first region. In some embodiments, after the response module 410 receives a service intention or a service request, the judgement module 420 may determine a possibility to locate the target service provider in the first region. The judgement module 420 may also determine whether there is at least one available service provider in the first region or determine a possibility that a time interval of waiting for a service request associated with the online to offline service made by the service requester being accepted by an available service provider in the first region is greater than an interval threshold. If the possibility to locate the target service provider in the first region or the possibility that the time interval is greater than the interval threshold, the judgement module 420 may determine to send a scheduling message to the requester terminal 130. Furthermore, if the response module 410 receives a requester response indicating that the service requester agrees with the transport capacity scheduling, the judgement module 420 may determine to locate the target service provider in the second region. In some embodiments, before the target service requester is located in the second region, if the detection module 420 detects at least one available service provider in the first region and no other service requester is waiting for an available service provider ahead of the service requester, the judgement module 420 may determine to locate the target service provider in the first region. In some embodiments, if the response module 410 receives a requester response indicating that the service requester disagrees with the transport scheduling, the judgement module 420 may determine not to locate the target service provider in the second region.

The transmission module 430 may transmit information to the requester terminal 130 associated with the service provider. In some embodiments, the transmission module 430 may transmit a scheduling message reminding the service requester that there may not be enough available service providers in the first region and may recommend to schedule an available service provider in the second region. In some embodiments, the scheduling message may include an extra fee required for scheduling an available service provider in the second region. In some embodiments, along with the scheduling message, the transmission module 430 may also transmit a user guidance associated with the online to offline service and/or special offers associated with the transportation capacity scheduling to the requester terminal 130. In some embodiments, the transmission module 430 may transmit a scheduling list including one or more candidate service providers and the travel times, the travel distances, the scheduling prices, or the like, corresponding to the one or more candidate service providers. In some embodiments, the transmission module 430 may transmit information related to the service request to the target service provider located in the first region or the second region as determined by the scheduling module 480. For example, the information related to the service request may include a start location, a destination, a contact number of the service requester, or the like, or any combination thereof. In some embodiments, after the target service provider accepts the service request, the transmission module 430 may transmit information related to the target service provider to the service requester, such as the plate number, the model and the color of the vehicle associated with the service provider, the contact number of the service provider, the name of the service provider, etc.

The detection module 440 may determine whether the response module 410 receives a requester response from the requester terminal 130 associated with the service requester. In some embodiments, the detection module 440 may also determine whether the requester response is a positive response or a negative response. The positive response may suggest that the service provider allows allocating the service request to a service provider in the second region. The negative response may suggest that the service provider does not allow allocating the service request to a service provider in the second region. In some embodiments, the detection module 440 may detect a number count of available service providers in the first region and/or the second region. In some embodiments, the detection module 440 may continuously or periodically monitor the transport capacity in the first region before obtaining the requester response.

The assigning module 450 may assign the service request to a target service provider in the first region. In some embodiments, the assigning module 450 may assign the service request to a target service in the first region if the detection module 440 detects at least one available service providers in the first region and there are no other service requests ahead of the service request in a queue waiting to be allocated to a service provider in the first region.

The determination module 460 may perform determinations related to the scheduling of the transport capacity. In some embodiments, the determination module 460 may determine the second region based on a maximum scheduling distance. For example, the maximum scheduling distance may be a preset maximum scheduling distance. As another example, the determination module 460 may determine the maximum scheduling distance based on a maximum scheduling fee and/or a maximum travel time set by the service provider. The travel time may refer to a time period required by the target service provider to travel from the current location of the target service provider to the start location of the service requester. In some embodiments, the determination module 460 may select one or more candidate service providers based on the travel time times, the travel distances, the scheduling fees, or the like, or any combination thereof. In some embodiments, the service requester may determine the target service provider from the one or more candidate service providers according to personal preferences related to the travel times, the travel distances, the scheduling fees, or the like, or any combination thereof.

The estimation module 470 may estimate data related to the selected one or more candidate service providers. In some embodiments, for each of the selected one or more candidate service providers, the estimation module 470 may determine a travel distance, a scheduling fee (also referred to as a “scheduling price”), the travel times, or the like, or any combination thereof. In some embodiments, the estimation module 470 may estimate a waiting time of the service request in the waiting queue based on a number of service requests made ahead of the service request in the waiting queue and the transportation capacity of the first region.

The scheduling module 480 may locate the target service provider in the second region and/or the first region. In some embodiments, the scheduling module 480 may locate the target service provider in the second region from the one or more candidate service providers based on the selection made by the service requester. In some embodiments, if the service requester cancels the service request later than a predetermined time interval after the service provider located in the second region accepts the service request, the service requester may need to pay a compensation fee to the service provider. The time interval may be, for example, 3 minutes, 4 minutes, 5 minutes, etc.

The ranking module 490 may rank the selected one or more candidate service providers. In some embodiments, the ranking module 490 may rank the selected one or more candidate service providers in descending order based on the travel times, the travel distances, or the scheduling prices, or other factors corresponding to the one or more candidate service providers. In some embodiments, the ranking module 490 may determine a weighted average of at least two of the travel time, the travel distance, or the scheduling price for each of the selected one or more candidate service providers. The ranking module 490 may rank the selected one or more candidate service providers in descending order based on the weighted average. In some embodiments, the ranking module 490 may generate a scheduling list including one or more candidate service providers ranked in descending order and the travel times, the travel distances, the scheduling prices, or the like, corresponding to the one or more candidate service providers.

The modules in the processing engine 112 may be connected to or communicate with each other via a wired connection or a wireless connection. The wired connection may include a metal cable, an optical cable, a hybrid cable, or the like, or any combination thereof. The wireless connection may include a Local Area Network (LAN), a Wide Area Network (WAN), a Bluetooth, a ZigBee, a Near Field Communication (NFC), or the like, or any combination thereof. Two or more of the modules may be combined as a single module, and any one of the modules may be divided into two or more units. For example, the assigning module 450 may be integrated in the scheduling module 480 as a single module which may determine a target service provider for a service requester from a first region and/or a second region. As another example, the transmission module 430 may be divided into two units. The first unit may be configured to transmit a scheduling message to the requester terminal 130. The second unit may be configured to transmit the information associated with the target service provider to the requester terminal 130.

It should be noted that the above description of the processing engine 112 is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. For example, the processing engine 112 may further include a storage module (not shown in FIG. 4). The storage module may be configured to store data generated during any process performed by any component of in the processing engine 112. As another example, each of components of the processing engine 112 may include a storage device. Additionally or alternatively, the components of the processing engine 112 may share a common storage device.

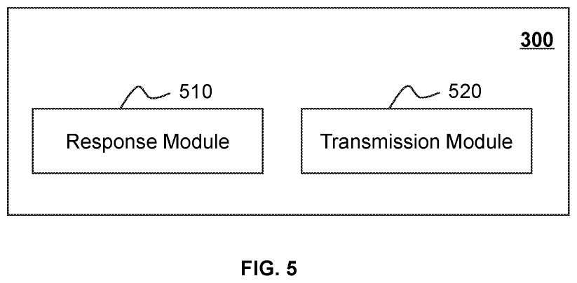

FIG. 5 is a block diagram illustrating an exemplary mobile device according to some embodiments of the present disclosure. In some embodiments, the mobile device 300 shown in FIG. 5 may be implemented on the requester terminal 130 of the online to offline service system 100 shown in FIG. 1. In some embodiments, the mobile device 300 shown in FIG. 5 may include a response module 510 and a transmission module 520.

The response module 510 may receive information from the server 110 (e.g., the processing engine 112). In some embodiments, the response module 510 may receive an estimated waiting time in the queue for assigning the service request to a service provider located in the first region. In some embodiments, the response module 510 may receive a scheduling message reminding the service requester that there may not be enough available service providers in the first region and may recommend to schedule an available service provider in the second region. In some embodiments, the response module 510 may obtain an operation instruction of the service requester on the editing information and convert the operation instruction into a requester response. The service requester may be reminded to provide information associated with the transport capacity scheduling (e.g., the maximum scheduling price, the longest travel time, or whether to allow locating the target service provider in the second region) to determine the second region. In some embodiments, the response module 510 may receive a scheduling list including the selected one or more candidate service providers and the travel times, the travel distances, or the scheduling prices of the selected one or more candidate service providers to the service requester to prompt the service requester to select one of the selected one or more candidate service providers as the target service provider.

The transmission module 520 may transmit information related to the service request to the server 110 (e.g., the processing engine 112). In some embodiments, the transmission module 520 may transmit a requester response of a service provider to the processing engine 112. For example, the requester response may include a positive that the service requester allows locating the target service provider in the second region or a negative response that the service requester does not allow locating the target service provider in the second region. In some embodiments, the transmission module 520 may transmit data associated with the transport capacity scheduling (e.g., the maximum scheduling price, the longest travel time) set by the service provider to the processing engine 112. In some embodiments, the transmission module 520 may transmit the selection of the target service provider from the one or more selected candidate service requesters to the processing engine 112.

It should be noted that the above description of the computing device 300 is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. For example, the mobile device 300 may further include a storage module (not shown in FIG. 5). The storage module may be configured to store data generated during any process performed by any component of in the mobile device 300. As another example, each of components of the mobile device 300 may include a storage device. Additionally or alternatively, the components of the mobile device 300 may share a common storage device.

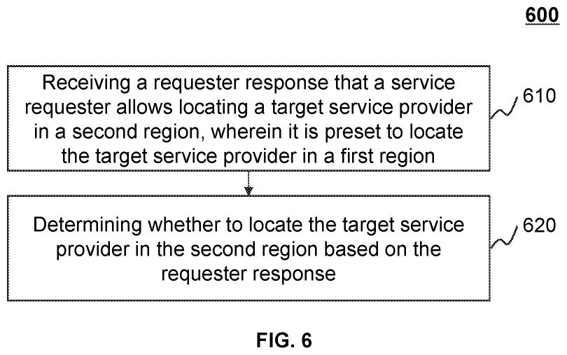

FIG. 6 is a flowchart illustrating an exemplary process for transport capacity scheduling according to some embodiments of the present disclosure. In some embodiments, the process 600 may be implemented in the online to offline service system 100 illustrated in FIG. 1. For example, the process 600 may be stored in a storage medium (e.g., the storage device 150, or the storage 220 of the processing engine 112) as a form of instructions, and invoked and/or executed by the server 110 (e.g., the processing engine 112 of the server 110, the processor 220 of the processing engine 112, or one or more modules in the processing engine 112 illustrated in FIG. 4). The operations of the illustrated process 600 presented below are intended to be illustrative. In some embodiments, the process 600 may be accomplished with one or more additional operations not described, and/or without one or more of the operations discussed. Additionally, the order in which the operations of the process 600 as illustrated in FIG. 6 and described below is not intended to be limiting.

In 610, the response module 410 (or the processing engine 112, and/or the interface circuits 210-a) may receive a requester response that a service requester allows locating a target service provider in a second region. In some embodiments, the online to offline service system 100 may be preset to locate the target service provider in a first region for the service requester.

In 620, the judgement module 420 (or the processing engine 112, and/or the processing circuits 210-b) may determine whether to locate the target service provider in the second region based on the requester response.

In some embodiments, by performing 610 and 620, the transport capacity scheduling of the second region may be optionally triggered by the service requester via the requester terminal 130. Therefore, on the one hand, the service requester may be allowed to select an acceptable scheduling price so as to reduce the occurrence of disputes. On the other hand, the transport capacity in the second region can be fully used so as to increase user experience of service requesters and service providers, the utilization of transport capacity, and a transaction volume of the online to offline service system 100.

In some embodiments, the target service provider may refer to the service requester that providers an online to offline service to the service requester. The target service provider may be an available service provider. For example, a service provider that is currently providing no service may be an available service provider. As another example, in a carpooling service, during a time period when a service provider is providing a service to a service request, if it is possible for the service provider to accept another service request, the service provider may be an available service provider.

In some embodiments, the first region may include a departure location associated with the service requester. For example, the first region may be a circle centered at the departure location and having a radius of a preset value (e.g., 3 km), a grid including the departure location, or a region that includes the departure location and is associated with latitude and longitude.

In some embodiments, the second region may be different from the first region. For example, the second region may be out of the first region. As another example, the second region may be larger than and include the first region. As a further example, the first region and the second region may be partially overlapped.

In some embodiments, before 610, the judgement module 420 may determine that the service requester intends to request an online to offline service (e.g., an online taxi-hailing service). The online to offline service may include a departure location. When receiving a service request or a service intention from the requester terminal 130, the judgement module 420 may determine that the service requester intends to request an online to offline service.

In some embodiments, the requester terminal 130 and/or the provider terminal 140 may establish a communication (e.g., wireless communication) with the server 110 (e.g., the processing engine 112), through an application (e.g., the application 380 in FIG. 3) installed in the requester terminal 130 and/or the provider terminal 140 via the network 120. The application may be associated with the online to offline service system 100. For example, the application may be a taxi-hailing application associated with the online to offline service system 100. As another example, the application may be a take-out service application associated with the online to offline service system 100. As a further example, the application may be an express delivery application associated with the online to offline service system 100.

In some embodiments, a service request may refer to information of an online to offline service that is formally requested and sent out by a service requester to the server 110 via the requester terminal 130. For example, when the service requester sends out the information of the online to offline service to the server 110, the service requester may do so by pressing a button on the interface of the application installed in the requester terminal 130. Upon receiving the information of the online to offline service, the server 110 may determine that the information of the online to offline service is formally sent out and determine the information of the online to offline service as a service request.

In some embodiments, a service intention may indicate an interest in requesting an online to offline service. In certain embodiments, the service intention reflects a likelihood that a service request is made before it is actually being made. For example, the application installed in the requester terminal 130 may direct the requester terminal 130 to monitor, continuously or periodically, input from a service requester and transmit the input to the online to offline service system 100 via the network 120. Consequently, the requester terminal 130 may inform the online to offline service system 100 about the service requester's input in real-time or substantially real-time. As a result, when the service requester starts to input a departure location (e.g., an intended departure location) and/or a destination (e.g., an intended destination), the online to offline service system 100 may receive enough information to determine an intention of the service requester. For example, when the service requester inputs all or part of a depature location, and before sending out the depature location to the online to offline service system 100, the online to offline service system 100 may have already received the depature location, and determine that the service requester intends to request an online to offline service.

In some embodiments, the departure location and/or the destination may be a specified location input by a service requester through the requester terminal 130 (e.g., the I/O 350 in FIG. 3). The service requester may input the departure location and/or the destination through text, pictures, videos, voices, or the like, or any combination thereof. In some embodiments, the requester terminal 130 may automatically obtain the departure location and/or the destination. For example, an event such as “Traveling from location A to location B at 10:00 a.m. on Wednesday to attend a meeting” is recorded in a calendar in the requester terminal 130. The requester terminal 130 may automatically determine location A as the departure location based on the event in the calendar. In some embodiments, the requester terminal 130 may obtain its location (which is referred to as the location of the service requester) herein through a positioning technology in the requester terminal 130, for example, the GPS, GLONASS, COMPASS, QZSS, BDS, WiFi positioning technology, or the like, or any combination thereof.

In some embodiments, after determining that the service requester intends to request an online to offline service, the judgement module 420 may determine a possibility to locate the target service provider in the first region for the service requester. The judgement module 420 may determine whether there is at least one available service provider in the first region or determine a possibility that a time interval of waiting for a service request associated with the online to offline service made by the service requester being accepted by an available service provider in the first region is greater than an interval threshold (e.g., 1 minute, 2 minutes, 3 minutes, 5 minutes, 10 minutes, etc.). In some embodiments, where there are fewer available service providers in the first region, there is a higher possibility that a time interval of waiting for a service request associated with the online to offline service made by the service requester being accepted by an available service provider in the first region is greater than the interval threshold. In some embodiments, such a possibility is greater than the interval threshold, and there is a lower possibility to locate the target service provider in the first region for the online to offline service.

In some embodiments, in response to a determination that the possibility to locate the target service provider in the first region is greater than or equal to a first possibility threshold (e.g., 50%, 60%, 70%, 80%, 90%, etc.) (e.g., a determination that there is at least one available service provider in the first region or a determination that the possibility that a time interval of waiting for a service request associated with the online to offline service being accepted by an available service provider in the first region is greater than the interval threshold is less than or equal to a second possibility threshold (e.g., 50%, 60%, 70%, 80%, 90%, etc.)), the assigning module 450 (or the processing engine 112, and/or the processing circuits 210-b) may assign an available service provider located in the first region to the service requester. In some embodiments, in response to a determination that the possibility to locate the target service provider in the first region is less than the first possibility threshold (e.g., a determination that there is no available service provider in the first region or a determination that the possibility that a time interval of waiting for a service request associated with the online to offline service being accepted by an available service provider in the first region being greater than the interval threshold is greater than the second possibility threshold), the transmission module 430 (or the processing engine 112, and/or the processing circuits 210-b) may transmit a scheduling message to the requester terminal 130 associated with the service requester. The scheduling message may be configured to inquire whether the service requester allows locating the target service provider in the second region that is different from the first region.

In some embodiments, the transmission module 430 may transmit the scheduling message to the requester terminal 130 associated with the service requester in response to a determination that a time interval of waiting for a service request that is made the service requester being accepted by an available service provider in the first region is greater than the interval threshold.

In some embodiments, the scheduling message may remind the service requester that the available service providers in the first region may be not enough and scheduling available service providers from a farther region away from the departure location may be recommended to increase the travel efficiency. In this way, on one hand, the situation in which a service requester waits too long and cancels a service request may be reduced, and on the other hand, dissatisfaction and anxiety of the service requester in the process of waiting may be reduced so as to improve the user experience.

In some embodiments, for a new user of the online to offline service system 100, the transmission module 430 may transmit, along with the scheduling message, a user guidance associated with the online to offline service and/or special offers associated with the transportation capacity scheduling to the requester terminal 130, which may further improve the user experience and the promotion of the online to offline service (e.g., the online taxi-hailing service).

In some embodiments, the detection module 440 (or the processing engine 112, and/or the processing circuits 210-b) may determine whether the response module 410 receives a requester response on the scheduling message transmitted from the requester terminal 130 after the scheduling message is transmitted to the requester terminal 130.

In some embodiments, the requester response may be a positive response that the service requester allows locating the target service provider in the second region or a negative response that the service requester does not allow locating the target service provider in the second region. In some embodiments, the positive response may include or not include a longest travel time that is approved by the service requester for the target service provider to travel to the departure location (or “longest travel time” for short), and/or a maximum scheduling price that is approved by the service requester to pay for assigning the target service provider to travel to the departure location before fulfilling the online to offline service (or “maximum scheduling price” for short).

In some embodiments, the operation of determining whether the response module 410 receives a requester response on the scheduling message transmitted from the requester terminal 130 after the scheduling message is transmitted to the requester terminal 130 may improve the timeliness of processing the requester response and the user experience, and increase the efficiency of processing the service requests.

In some embodiments, in a condition that the response module 410 receives a service request from the service requester before the transmission module 430 transmits the scheduling message, during a time interval between transmitting the scheduling message and obtaining the requester response, the assigning module 450 may assign an available service provider located in the first region to the service requester in response to a determination that there is at least one available service provider in the first region.

In some embodiments, the detection module 440 may continuously or periodically monitor the transport capacity in the first region during the time interval between transmitting the scheduling message and obtaining the requester response, so as to improve the efficiency of assigning available service providers. If the detection module 440 detects that there is at least one available service provider in the first region, the assigning module 450 may assign an available service provider located in the first region to the service requester, so as to save scheduling cost and the waiting time, and further improve user experience.

In some embodiments, the scheduling module 480 (or the processing engine 112, and/or the processing circuits 210-b) may locate the target service provider in the second region when the detection module 440 determines that the requester response is a positive response. In this way, the transport capacity scheduling of the second region may be optionally triggered by the service requester's own choice through the requester terminal 130.

In some embodiments, in a condition that the response module 410 receives a service request from the service requester before the transmission module 430 transmits the scheduling message, the scheduling module 480 may locate the target service provider in the second region for the service requester. In a condition that the response module 410 detects a service intention from the service requester before the transmission module 430 transmits the scheduling message, after the response module 410 receives a service request from the service requester, the scheduling module 480 may locate the target service provider in the first region and the second region for the service requester.

In some embodiments, the determination module 460 (or the processing engine 112, and/or the processing circuits 210-b) may determine a maximum scheduling distance to determine the second region. The maximum scheduling distance may be the maximum distance between the target service provider and the departure location of the online to offline service.

In some embodiments, in response to a determination that the positive response includes a longest travel time that is approved by the service requester for the target service provider to travel to the departure location, and/or a maximum scheduling price that is approved by the service requester to pay for assigning the target service provider to travel to the departure location before fulfilling the online to offline service, the determination module 460 may determine the maximum scheduling distance according to the maximum scheduling price and/or the longest travel time approved by the service requester, so that the cost dispute may be reduced while the user experience and the utilization of transport capacity may be increased.

In some embodiments, the determination module 460 may determine a maximum scheduling distance according to a ratio of the maximum scheduling price to a preset scheduling price per kilometer, and/or the longest travel time.

Merely by way of example, the first region may be a circle centered at the departure location of the online to offline service and having a radius of 3 kilometers, the maximum scheduling price may be 10 CNY, and the preset scheduling price per kilometer may be 4 CNY, then the maximum scheduling distance may be 5.5 (i.e., 3+10/4) kilometers. Therefore, the maximum distance from the target service provider to the departure location of the online to offline service may be 5.5 kilometers.

In some embodiments, when the determination module 460 determines the maximum scheduling distance based on the longest travel time, besides the longest travel time, other factors such as but not limited to road condition (e.g., a traffic jam, rate limiting) and/or weather may be considered.

In some embodiments, when determining the maximum scheduling distance based on the maximum scheduling price and the longest travel time, the determination module 460 may determine a first scheduling distance according to the ratio of the maximum scheduling price to the preset scheduling price per kilometer, and a second scheduling distance according to the longest travel time. The determination module 460 may determine the larger one of the first scheduling distance and the second scheduling distance as the maximum scheduling distance.

In some embodiments, in response to a determination that the positive response does not include the longest travel time and/or the maximum scheduling price, the determination module 460 may determine a preset distance (e.g., 5 km) as the maximum scheduling distance.

In some embodiments, the determination module 460 may determine the second region based on the maximum scheduling distance. For example, the second region may be totally included in a circle centered at the departure location and having a radius equal to the maximum scheduling distance. For example, the second region may be the circle centered at the departure location and having a radius equal to the maximum scheduling distance. As another example, the second region may be the circle centered at the departure location and having a radius equal to the maximum scheduling distance excluding the first region. As yet another example, the maximum scheduling distance may be a navigation distance; the second region may be a polygonal shape based on various roads leading to the departure location where the limit of the region is defined by connecting the far ends of the roads from each of which the navigation distance being equal to or less than the maximum scheduling distance.

In some embodiments, the determination module 460 may perform a Kuhn-Munkras (KM) algorithm to give preference to available service providers closer to the departure location in the second region to ensure the global optimum. The determination module 460 may obtain the available service providers in the second region (e.g., also referred to as candidate service providers). For each of the candidate service providers, the determination module 460 may determine a travel time to the departure location (or “travel time” for short), a travel distance to the departure location (or “travel distance” for short), or a scheduling price that the service requester pays for assigning the each of the candidate service providers to travel to the departure location (or “scheduling price” for short). The determination module 460 may select one or more candidate service providers based on the travel times, travel distances, or scheduling prices. For example, the travel distances related to the selected one or more candidate service providers may be less than a distance threshold (e.g., 1 km, 2 km, 3 km, 5 km). As another example, the scheduling prices related to the selected one or more candidate service providers may be less than a price threshold (e.g., 5 CNY, 10 CNY). As a further example, the travel times related to the selected one or more candidate service providers may be less than a time threshold (e.g., 1 minute, 2 minutes, 3 minutes, 5 minutes).

In some embodiments, when a candidate service provider is also located in the first region, the scheduling price relating to the candidate service provider may be equal to 0. When a candidate service provider is located out of the first region, the scheduling price relating to the candidate service provider may be determined based on the distance between the candidate service provider and the departure location of the online to offline service.

In some embodiments, the determination module 460 may automatically select one or more candidate service providers by performing the KM algorithm, which may improve the efficiency of transport capacity scheduling, reduce the pressure of data exchange of the server 110, and facilitate the assigning of a preferable service provider to the service requester within a relatively short period of time.

In some embodiments, to select the one or more candidate service providers, the determination module 460 may search, in the second region, the candidate service providers closest to the departure location. When the number of the candidate service providers closest to the departure location is less than a number threshold (e.g., 1, 2, 3, 5, 10, 15, 20), the determination module 460 may enlarge the search range in the second region until the number of the searched candidate service providers is equal to or greater than the number threshold or the search range is equal to the second region.

In some embodiments, the estimation module 470 (or the processing engine 112, and/or the processing circuits 210-b) may determine the travel distances, the scheduling prices, or the travel times associated with the selected one or more candidate service providers.

The transmission module 430 may transmit a scheduling list including the selected one or more candidate service providers and the travel times, the travel distances, or the scheduling prices of the selected one or more candidate service providers to the service requester to prompt the service requester to select one of the selected one or more candidate service providers. The service requester may select a preferred available service provider from the received scheduling list so as to reduce the scheduling price and the waiting time. In this way, the service requester may select a preferred service provider based on his/her own needs, which may improve the user experience and the transaction volume of the online to offline service system 100, and facilitate the promotion of the online to offline service.

In some embodiments, in the scheduling list, the selected one or more candidate service providers may be ranked based on the travel times, the travel distances, or the scheduling prices of the selected one or more candidate service providers. For example, the ranking module 490 (or the processing engine 112, and/or the processing circuits 210-b) may rank the selected one or more candidate service providers in descending order based on the travel times, the travel distances, or the scheduling prices. As another example, the ranking module 490 may determine a weighted average of at least two of the travel time, the travel distance, or the scheduling price for each of the selected one or more candidate service providers. The ranking module 490 may rank the selected one or more candidate service providers in descending order based on the weighted average.

In some embodiments, the scheduling module 480 (or the processing engine 112, and/or the processing circuits 210-b) may determine the target service provider based on the selection of the service requester. In this way, the service requester may actively trigger the selection of the target service provider through the requester terminal 130, so that the utilization of transport capacity may be increased, meanwhile the occurrence of disputes may be reduced and the user experience may be further improved.

In some embodiments, the server 110 (e.g., the processing engine 112) may automatically determine, without the service requester's own choice, a target service provider for the service requester. For example, the server 110 (e.g., the processing engine 112) may designate a candidate service provider of which the travel distance is shortest, the travel time is shortest, or the scheduling price is lowest among all candidate service providers in the second region as the target service provider.

In some embodiments, in response to a determination that the requester response is a positive response not including the maximum scheduling price and the longest travel time, a determination that the requester response is a negative response, or a determination that the response module 410 does not receive a requester response, for a condition that the response module receives a service request from the service requester before the transmission module 430 transmits the scheduling message, the judgement module 420 may determine to not locate the target service provider in the second region. The ranking module 490 may obtain a time point at which the service requester sends a service request to the server 110 (e.g., the processing engine 112). The ranking module 490 may rank the service request into a waiting queue according to the time point at which the service requester sends the service request to the server 110, which may ensure that the transport capacity may be orderly and fairly allocated to the service request. The estimation module 470 may estimate a waiting time of the service request in the waiting queue according to a number of service requests ahead of the service requester in the waiting queue and the transportation capacity of the first region. The transmission module 430 may transmit the waiting time of the service request in the waiting queue to the requester terminal 130, which may let the service requester clearly understand the waiting time of the service request in the waiting queue, make travel arrangement, and improve the user experience. For a condition that the response module 410 receives a service intention from the service requester before the transmission module 430 transmits the scheduling message, after the response module 410 receive a service request from the service requester, the assigning module 450 may locate the target service provider in the first region.

In some embodiments, the transmission module 430 may transmit information relating to the target service provider to the requester terminal 130. For example, in the online taxi-hailing service, the information relating to the target service provider may include the distance between the target service provider and the departure location, the travel time of the target service provider to the departure location, the color of a vehicle associated with the target service provider, the vehicle type, the plate number of the vehicle, the name of the target service provider, the phone number of the target service provider, the rate of positive feedback, or the like, or any combination thereof.

It should be noted that the above description is merely provided for the purposes of illustration, and not intended to limit the scope of the present disclosure. For persons having ordinary skills in the art, multiple variations or modifications may be made under the teachings of the present disclosure. However, those variations and modifications do not depart from the scope of the present disclosure.

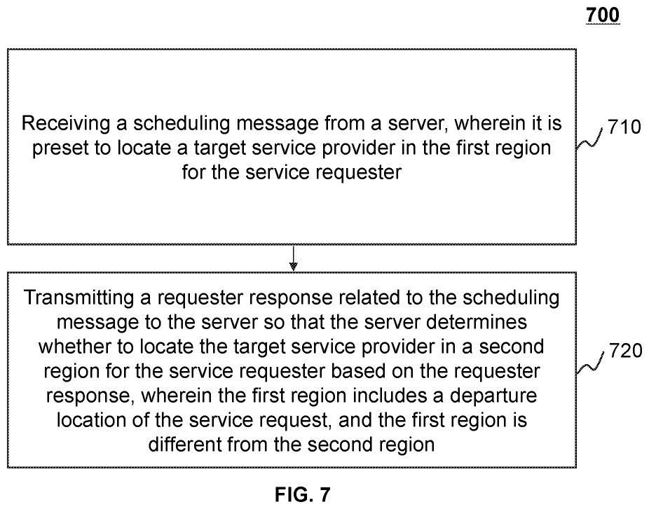

FIG. 7 is a flowchart illustrating an exemplary process for transport capacity scheduling according to some embodiments of the present disclosure. In some embodiments, the process 700 may be implemented in the online to offline service system 100 illustrated in FIG. 1. For example, the process 700 may be stored in a storage medium (e.g., the storage device 150, or the storage 390 of the requester terminal 130) as a form of instructions, and invoked and/or executed by the requester terminal 130 (e.g., the GPU 330 of the requester terminal 130, the CPU of the requester terminal 130, or one or more modules in the requester terminal 130 illustrated in FIG. 5). The operations of the illustrated process 700 presented below are intended to be illustrative. In some embodiments, the process 700 may be accomplished with one or more additional operations not described, and/or without one or more of the operations discussed. Additionally, the order in which the operations of the process 700 as illustrated in FIG. 7 and described below is not intended to be limiting.

In 710, the response module 510 may receive a scheduling message from the server 110 (e.g., the processing engine 112). The online to offline service system 100 may be preset to locate a target service provider in a first region for a service requester.

In 720, the transmission module 520 may transmit a requester response related to the scheduling message to the server 110 (e.g., the processing engine 112) so that the server 110 may determine whether to locate the target service provider in a second region for the service requester based on the requester response. The first region may be a region including a departure location associated with the service requester, and the first region may be different from the second region.

In some embodiments, after the server 110 (e.g., the processing engine 112) determines that a possibility to locate the target service provider in the first region is less than a first possibility threshold (e.g., a time interval of waiting for a service request made by the service requester being accepted by an available service provider in the first region is greater than an interval threshold), the response module 510 may receive the scheduling message transmitted from the server 110 (e.g., the processing engine 112) so as to remind the service requester that the available service providers in the first region may be not enough and scheduling available service providers from a farther region away from the service requester may be recommended to increase the travel efficiency. In this way, on the one hand, the situation in which a service requester waits too long and cancels a service request may be reduced, and on the other hand, dissatisfaction and anxiety of the service requester in the process of waiting may be reduced so as to improve the user experience.

In some embodiments, for a new user of the online to offline service system 100, the server 110 (e.g., the processing engine 112) may transmit, along with the scheduling message, a user guidance associated with the online to offline service and/or special offers associated with the transportation capacity scheduling to the requester terminal 130, which may further improve the user experience and the promotion of the online to offline service (e.g., the online taxi-hailing service).

In some embodiments, the scheduling massage may direct the requester terminal 130 to display editing information for inputting a longest travel time that is approved by the service requester for the target service provider to travel to the departure location, and/or a maximum scheduling price that is approved by the service requester to pay for assigning the target service provider to travel to the departure location before fulfilling the online to offline service. Alternatively or additionally, the scheduling massage may direct the requester terminal 130 to display editing information for determining whether to allow locating the target service provider in the second region.

In some embodiments, the editing information may be in a form of an input box to let the service requester input text, pictures, videos, voices, or the like, or any combination thereof. For example, the service requester may input the maximum scheduling price and/or the longest travel time. As another example, the service requester may input information relating to whether to allow locating the target service provider in the second region, such as the text of “Yes” or “No.”

In some embodiments, the editing information may be in a form of a list including one or more scheduling prices and/or one or more travel times. The service requester may select one of the one or more scheduling prices as the maximum scheduling price and/or select one of the one or more travel times as the longest travel time.

In some embodiments, the editing information may be in a form of icons. For example, the service requester may press an icon (e.g. with the text “Yes”) to allow locating the target service provider in the second region or another icon (e.g. with the text “No”) to refuse locating the target service provider in the second region. As another example, the service requester may press a green icon to allow locating the target service provider in the second region or a red icon to refuse locating the target service provider in the second region.

In some embodiments, the response module 510 may obtain an operation instruction of the service requester on the editing information and convert the operation instruction into a requester response. In this way, the service requester may be reminded to provide information associated with the transport capacity scheduling (e.g., the maximum scheduling price, the longest travel time, or whether to allow locating the target service provider in the second region) to determine the second region.

By obtaining the operation instruction of the service requester on the editing information and converting the operation instruction into the requester response, the service requester may actively trigger the transport capacity scheduling of the second region through the requester terminal 130, and the service requester may also actively select an acceptable scheduling price and/or waiting time. In this way, the transport capacity in the second region may be fully used, the utilization of transport capacity may be increased, the occurrence of disputes may be reduced, and the user experience may be further improved.

In some embodiments, the requester terminal 130 may display the departure location, the destination, the scheduling message, the first region, the second region, the waiting time for an available service provider, information associated with the waiting queue, or information associated with the target service provider in forms of text, pictures, videos, voices, or the like, or any combination thereof.

It should be noted that the above description is merely provided for the purposes of illustration, and not intended to limit the scope of the present disclosure. For persons having ordinary skills in the art, multiple variations or modifications may be made under the teachings of the present disclosure. However, those variations and modifications do not depart from the scope of the present disclosure.

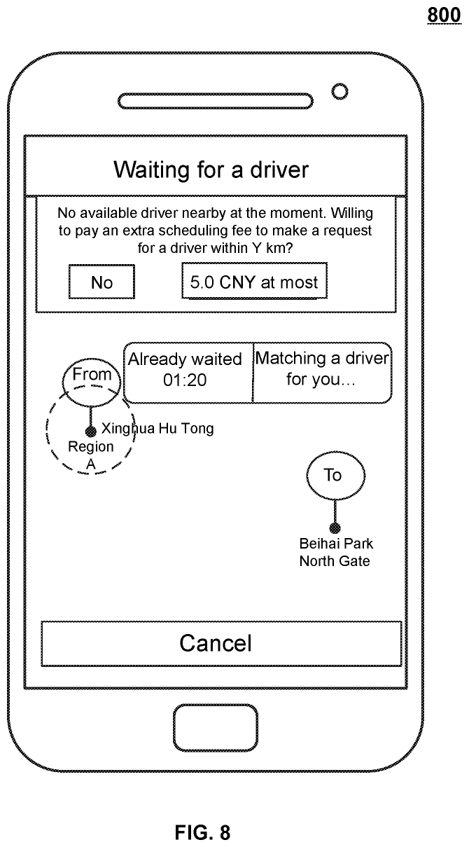

FIGS. 8 to 10 are schematic diagrams of an interface of a requester terminal associated with a service requester according to an embodiment of the present disclosure. Interfaces 800-1000 relate to an application (e.g., a taxi-hailing application) installed in the requester terminal 130 associated with a service requester. FIGS. 8-10 relates to a condition of transmitting a scheduling massage to the service requester after the service requester sends out a formal service request using the requester terminal 130.

As shown in FIGS. 8 to 10, “Xinghua Hu Tong” is a departure location of the service request. “Beihai Park North Gate” is a destination of the service request. Region A is the first region that is preset to locate a target service provider for the service requester.

The service requester has already been waiting for 2 minutes and 20 seconds that are greater than an interval threshold (e.g., 1 minute) before an available service provider in region A (e.g., the first region) accepts the service request. In this case, the server 110 (e.g., the processing engine 112) may transmit a scheduling message to the requester terminal 130. The requester terminal 130 may display the scheduling message in forms of, for example, the text of “No available driver nearby at the moment. Willing to pay an extra scheduling price to make a request for a driver within Y km,” a button with “No”, and a button with “5.0 CNY at most” that is the maximum scheduling price.

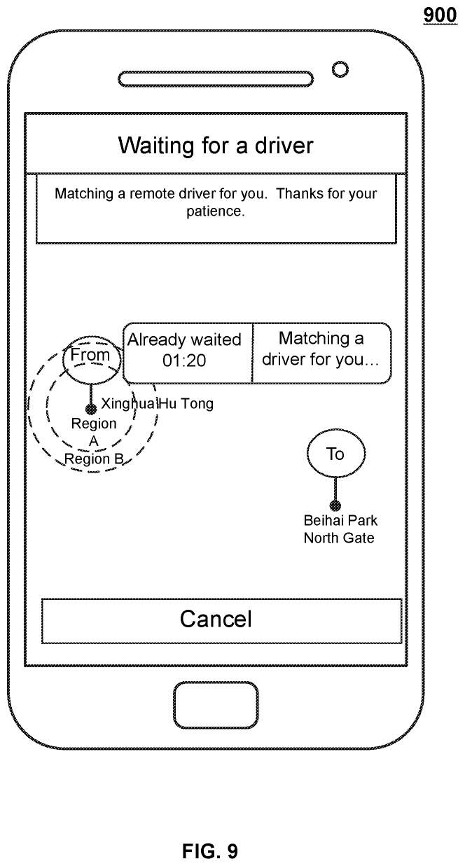

If the service requester presses the button with “5.0 CNY at most,” which means the service requester allows locating a target service provider in the second region and the maximum scheduling price is 5.0 CNY, the server 110 (the processing engine 112) may determine the second region based on the maximum scheduling price and transmit signals, codes, or instructions to the requester terminal 130 to direct the requester terminal 130 to display the second region (e.g., region B) on the interface (as shown in FIG. 9).

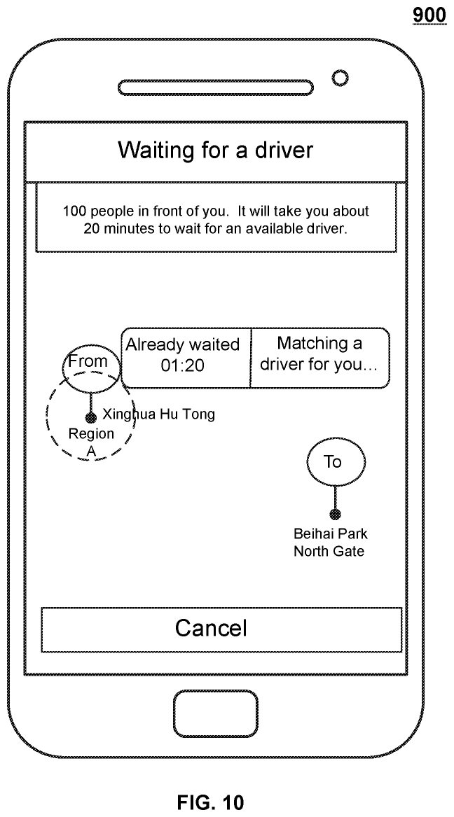

If the service requester presses the button with “No,” which means the service requester refuses locating the target service provider in the second region, the server 110 (e.g., the processing engine 112) may rank the service request into a waiting queue according to a time point at which the service requester initiates the service request. The server 110 (e.g., the processing engine 112) may transmit information associated with the number of service requests that are ahead of the service requester and an estimated waiting time of the service requester in the wait queue to the requester terminal 130. As shown in FIG. 10, the requester terminal 130 displays the text of “100 people in front of you. It will take you about 20 minutes to wait for an available driver” on the interface of the requester terminal 130.

It should be noted that the above description is merely provided for the purposes of illustration, and not intended to limit the scope of the present disclosure. For persons having ordinary skills in the art, multiple variations or modifications may be made under the teachings of the present disclosure. However, those variations and modifications do not depart from the scope of the present disclosure.

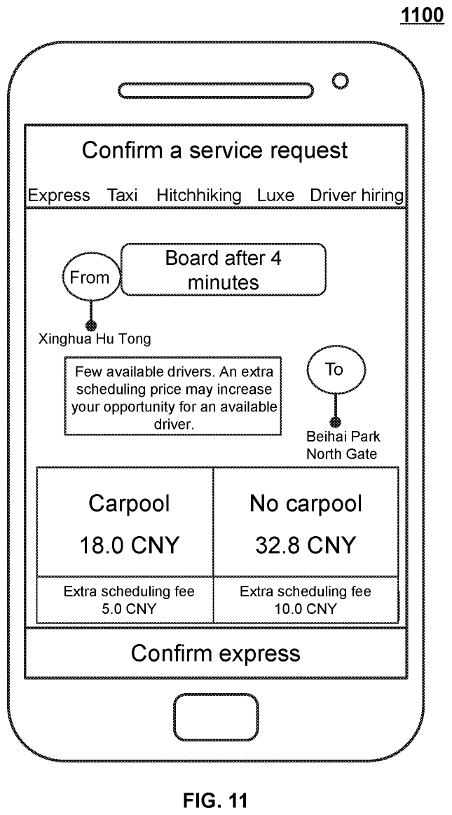

FIGS. 11 to 13 are schematic diagrams of an interface of a requester terminal according to another embodiment of the present disclosure. Interfaces 1100-1300 relate to an application (e.g., a taxi-hailing application) installed in the requester terminal 130 associated with a service requester. FIGS. 11-13 relates to a condition of transmitting a scheduling massage to the service requester after a service intention is received from the requester terminal 130.

As shown in FIGS. 11 to 13, “Xinghua Hu Tong” is an intended departure location of the service requester. “Beihai Park North Gate” is an intended destination of the service requester.

Immediately after the service requester input the intended departure location and the intended destination through the requester terminal 130, the server 110 (e.g., the processing engine 112) may determine a possibility to locate a target service provider in a first region for the service requester. In response to a determination that the possibility to locate the target service provider in the first region is less than a first possibility threshold, the server 110 (e.g., the processing engine 112) may transmit a scheduling message to the requester terminal 130. As shown in FIG. 11, the requester terminal 130 may display the scheduling message in forms of, for example, the text of “Few available drivers. An extra scheduling price may increase your opportunity for an available driver,” a button with “Extra scheduling fee 5.0 CNY,” and a button with “Extra scheduling fee 10.0 CNY.”

If the service requester determines to pay the extra scheduling price (e.g., the service requester presses the button with “Extra scheduling fee 5.0 CNY” or the button with “Extra scheduling fee 10.0 CNY”), the server 110 (e.g., the processing engine 112) may search for an available service provider for the service requester in both of the first region and the second region relating to the extra scheduling price after the service requester sends out a service request.

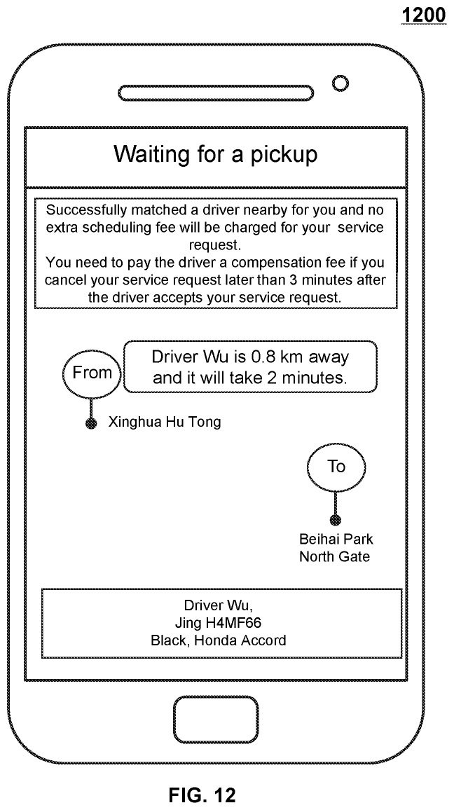

If the server 110 (e.g., the processing engine 112) locates a target service provider in the first region, no extra scheduling price will be charged for the service request. As shown in FIG. 12, the requester terminal 130 may display the text of “Successfully matched a driver nearby for you and no extra scheduling price will be charged for your service request. You need to pay the driver a compensation fee if you cancel your service request later than 3 minutes after the driver accepts your service request.”

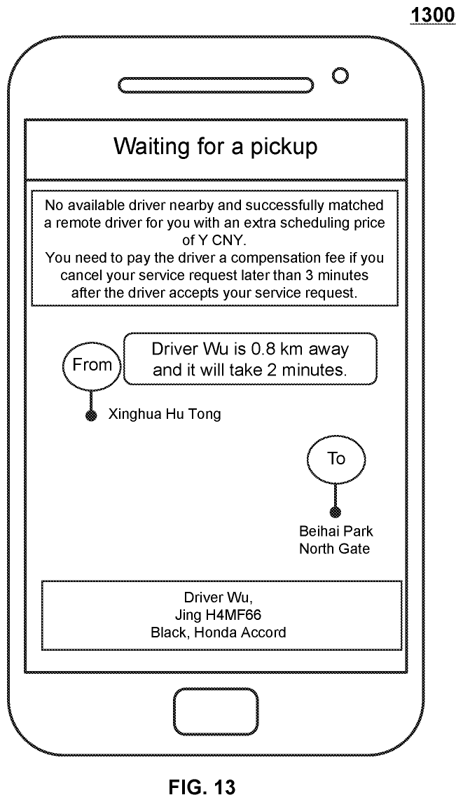

If the server 110 (e.g., the processing engine 112) locates a target service provider in the second region, the service requester will pay an extra scheduling price. As shown in FIG. 13, the requester terminal 130 may display the text of “No available driver nearby and successfully matched a remote driver for you with an extra scheduling price of Y CNY. You need to pay the driver a compensation fee if you cancel your service request later than 3 minutes after the driver accepts your service request.”

As shown in FIGS. 12-13, the requester terminal 130 may also display the name of the target service provider (e.g., Driver Wu), the distance between the target service provider and the departure location (e.g., 0.8 km), the travel time of the target service provider to the departure location (e.g., 2 minutes), the plate number (e.g., Jing H4MF66) of the vehicle associated with the target service provider, the color of the vehicle (e.g., black), and the brand of the vehicle (e.g., Honda Accord).

It should be noted that the above description is merely provided for the purposes of illustration, and not intended to limit the scope of the present disclosure. For persons having ordinary skills in the art, multiple variations or modifications may be made under the teachings of the present disclosure. However, those variations and modifications do not depart from the scope of the present disclosure.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “unit,” “module,” or “system.” Furthermore, aspects of the present disclosure may take the form of a computer program product embodied in one or more computer readable media having computer readable program code embodied thereon.

A computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C #, VB. NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server 110. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter may lie in less than all features of a single foregoing disclosed embodiment.

1. A system for transport capacity scheduling in an online to offline service, comprising:
at least one storage medium including a set of instructions;
at least one processor in communication with the at least one storage medium, wherein when executing the set of instructions, the at least one processor is directed to cause the system to:
determine that a service requester intends to request an online to offline service, the online to offline service including a departure location;
determine a possibility to locate a target service provider in a first region for the service requester;
in response to a determination that the possibility to locate the target service provider in the first region is less than a possibility threshold, transmit a scheduling message to a terminal of the service requester, the scheduling message being configured to inquire whether the service requester allows locating the target service provider in a second region that is different from the first region;
receive, from the terminal of the service requester, a requester response that the service requester allows locating the target service provider in the second region; and
determine the target service provider in the second region based on the requester response.

2. The system of claim 1, wherein to determine the possibility to locate the target service provider in the first region for the online to offline service, the at least one processor is directed to cause the system to:
determine whether there is at least one available service provider in the first region; or
determine a possibility that a time interval of waiting for a service request associated with the online to offline service being accepted by an available service provider in the first region is greater than an interval threshold.

3. The system of claim 1, wherein the requester response includes a longest travel time that is approved by the service requester for the target service provider to travel to the departure location, or a maximum scheduling price that is approved by the service requester to pay for assigning the target service provider to travel to the departure location before fulfilling the online to offline service; and
wherein the second region is determined based on at least one of the longest travel time or the maximum scheduling price.

4. The system of claim 1, wherein to determine the target service provider in the second region based on the requester response, the at least one processor is directed to cause the system to:
obtain a plurality of candidate service providers in the second region;
for each of the plurality of candidate service providers, determine a travel time to the departure location, a travel distance to the departure location, or a scheduling price that the service requester pays for assigning the each of the plurality of candidate service providers to travel to the departure location;
select one or more candidate service providers of the plurality of candidate service providers based on the travel times, travel distances, or scheduling prices, the travel distances related to the selected one or more candidate service providers being less than a distance threshold; and
locate the target service provider from the selected one or more candidate service providers.

5. The system of claim 4, wherein to select the one or more candidate service providers of the plurality of candidate service providers, the at least one processor is directed to cause the system to:
select the selected one or more candidate service providers using a Kuhn-Munkras (KM) algorithm.

6. The system of claim 4, wherein to locate the target service provider from the selected one or more candidate service providers, the at least one processor is directed to cause the system to:
transmit the scheduling prices or the travel times associated with the selected one or more candidate service providers to the terminal of the service requester to prompt the service requester to select one of the selected one or more candidate service providers; and
determine the target service provider based on a selection result received from the terminal of the service requester.

7. The system of claim 1, wherein to determine that the service requester intends to request the online to offline service, the at least one processor is directed to cause the system to:
detect that the service requester is inputting all or part of the departure location in an application on the terminal of the service requester before receiving a formal service request.

8. The system of claim 1, wherein to determine that the service requester intends to request the online to offline service, the at least one processor is directed to cause the system to:
receive a formal service request from the terminal of the service requester.

9. The system of claim 1, wherein when executing the set of instructions, the at least one processor is further directed to cause the system to:
transmit information relating to the target service provider to the terminal of the service requester.

10. The system of claim 1, wherein when executing the set of instructions, the at least one processor is further directed to cause the system to:
in response to a determination that the possibility to locate the target service provider in the first region is greater than or equal to the possibility threshold, locate the target service provider in the first region.

11. A method for transport capacity scheduling in an online to offline service, implemented on a computing device having at least one storage medium and at least one processor, the method comprising:
determining that a service requester intends to request an online to offline service, the online to offline service including a departure location;
determining a possibility to locate a target service provider in a first region for the service requester;
in response to a determination that the possibility to locate the target service provider in the first region is less than a possibility threshold, transmitting a scheduling message to a terminal of the service requester, the scheduling message being configured to inquire whether the service requester allows locating the target service provider in a second region that is different from the first region;
receiving, from the terminal of the service requester, a requester response that the service requester allows locating the target service provider in the second region; and
determining the target service provider in the second region based on the requester response.

12. The method of claim 11, wherein the determining of the possibility to locate the target service provider in the first region for the online to offline service includes:
determining whether there is at least one available service provider in the first region; or
determining a possibility that a time interval of waiting for a service request associated with the online to offline service being accepted by an available service provider in the first region is greater than an interval threshold.

13. The method of claim 11, wherein the requester response includes a longest travel time that is approved by the service requester for the target service provider to travel to the departure location, or a maximum scheduling price that is approved by the service requester to pay for assigning the target service provider to travel to the departure location before fulfilling the online to offline service; and
wherein the second region is determined based on at least one of the longest travel time or the maximum scheduling price.

14. The method of claim 11, wherein the determining of the target service provider in the second region based on the requester response includes:
obtaining a plurality of candidate service providers in the second region;
for each of the plurality of candidate service providers, determining a travel time to the departure location, a travel distance to the departure location, or a scheduling price that the service requester pays for assigning the each of the plurality of candidate service providers to travel to the departure location;
selecting one or more candidate service providers of the plurality of candidate service providers based on the travel times, travel distances, or scheduling prices, the travel distances related to the selected one or more candidate service providers being less than a distance threshold; and
locating the target service provider from the selected one or more candidate service providers.

15. The method of claim 14, wherein the selecting of the one or more candidate service providers of the plurality of candidate service providers includes:
selecting the selected one or more candidate service providers using a Kuhn-Munkras (KM) algorithm.

16. The method of claim 14, wherein the locating of the target service provider from the selected one or more candidate service providers includes:
transmitting the scheduling prices or the travel times associated with the selected one or more candidate service providers to the terminal of the service requester to prompt the service requester to select one of the selected one or more candidate service providers; and
determining the target service provider based on a selection result received from the terminal of the service requester.

17. The method of claim 11, wherein the determining that the service requester intends to request the online to offline service includes:
detecting that the service requester is inputting all or part of the departure location in an application on the terminal of the service requester before receiving a formal service request; or
receiving a formal service request from the terminal of the service requester.

18. (canceled)

19. The method of claim 11, further comprising:
transmitting information relating to the target service provider to the terminal of the service requester.

20. The method of claim 11, further comprising:
in response to a determination that the possibility to locate the target service provider in the first region is greater than or equal to the possibility threshold, locating the target service provider in the first region.

21-30. (canceled)

31. A non-transitory computer readable medium, comprising at least one set of instructions for transport capacity scheduling in an online to offline service, wherein when executed by one or more processors of a computing device, the at least one set of instructions causes the computing device to perform a method, the method comprising:
determining that a service requester intends to request an online to offline service, the online to offline service including a departure location;
determining a possibility to locate a target service provider in a first region for the service requester;
in response to a determination that the possibility to locate the target service provider in the first region is less than a possibility threshold, transmitting a scheduling message to a terminal of the service requester, the scheduling message being configured to inquire whether the service requester allows locating the target service provider in a second region that is different from the first region;
receiving, from the terminal of the service requester, a requester response that the service requester allows locating the target service provider in the second region; and
determining the target service provider in the second region based on the requester response.
